(19) United States
(12) Patent Application Publication
(10) Pub. No.: US 2020/0114986 A1
(43) Pub. Date: Apr. 16, 2020

(54) SPOILER FOR MOTOR VEHICLE COMPRISING MOBILE SCOOPS

(71) Applicant: COMPAGNIE PLASTIC OMNIUM, LYON (FR)

(72) Inventors: Yoann EULALIE, LYON (FR); Franck LETERRIER, SAINT PRIEST (FR); Philippe GILOTTE, BENONCES (FR)

(21) Appl. No.: 16/469,540

(22) PCT Filed: Dec. 4, 2017
(86) PCT No.: PCT/FR2017/053371

§ 371 Date: Jun. 13, 2019

(30) Foreign Application Priority Data
Dec. 14, 2016 (FR) 1662425

(51) Int. Cl. B62D 35/00; B62D 37/02

(52) U.S. Cl. CPC B62D 35/007; B62D 37/02

(57) ABSTRACT

The invention relates to a spoiler (4) for an automobile vehicle designed to be located in a region near a rear edge of the roof above a rear window (9), comprising:
several openings (8) located on an upper face of the spoiler (4), and
several conduits (12) designed to connect the openings (8) to a lower face of the spoiler (4),
   the spoiler (4) comprises several scoops (10; 110; 210) mounted in mobile openings (8) and free to move relative to the spoiler (4) so as to close off the openings (8) when in the folded position, and to perform a guidance function when in the extended position, to allow air flow along the rear window (9), the scoops (10; 110; 210) including means of generating vortex structures.

The invention relates to the field of automobiles, and particularly of automobile spoilers of the type comprising a device for cleaning the rear window.

A spoiler is a bodywork part forming an extension to the roof placed at the rear of a vehicle, and designed to improve the aerodynamic performances (at the rear) of the vehicle on which this part is placed. Spoilers are also used for aesthetic aspects (style) of the vehicle. They are located at and fixed to the top rear part of the vehicle between the roof and the top of the window, on the roof or on the rear door.

Some spoilers also act as rear window cleaning devices.

Classically, rain and dust are removed from the rear window by the rear window wiper and window washer. Unfortunately, rear window wipers and washers tend to be expensive, cumbersome and prone to damage. They are also used less frequently than windshield wipers and washers at the front and the weight of the system, including a motor to operate the wiper, can be a problem considering the objective to reduce weight.

This is why some spoilers are designed to direct part of the air circulating along the roof panel directly above the rear window. Consequently, dirt (rain, mud, dust, etc.) is pushed away from the rear window.

A spoiler comprising a hatch type moving element is also known, for example from document EP2711254A2. In the active position, the moving element projects from the upper or lower face of the spoiler, and the projection ratio (the projecting height) increases when the vehicle speed decreases so as to clean the rear window. Conversely, the projection ratio decreases when the speed increases to limit aerodynamic problems.

This type of spoiler is a solution that is not advantageous in terms of aerodynamic performances.

Thus, known systems for cleaning the rear window comprise a device projecting from the surface of the roof extension, to capture air circulating along the roof and redirect it downwards from the top part of the spoiler towards the bottom part of the spoiler. However, these devices have a negative effect on the aerodynamic performances of the vehicle, particularly at high speed.

Systems that do not require moving parts are also known. These devices comprise a permanently open conduit, passing through the thickness Z of the spoiler and opening up above the rear window, this conduit being adapted to passively allow part of the air flow from the roof to pass to the window. The conduit comprises an inlet and an outlet in the thickness (in Z) of the spoiler. Thus, air from the roof passively enters the inlet of the conduit, and then flows in the conduit, and finally comes out of the conduit at its outlet, at the upper portion of the outer face of the rear window.

However, such a conduit with an opening at roof level may have a negative effect on the aerodynamic performances of the vehicle, particularly at high speed.

One purpose of the invention is to eliminate or at least significantly limit some of the disadvantages mentioned above.

To achieve this, the purpose of the invention is a spoiler for an automobile vehicle designed to be located in a region of a rear edge of the roof above a rear window, comprising:
several openings located on an upper face of the spoiler, and
several conduits designed to connect the openings to a lower face of the spoiler, the spoiler comprises several scoops mounted in the openings and free to move relative to the spoiler so as to close off the openings when in the folded position, and to perform a guidance function when in the extended position, to allow air to flow along the rear window, the scoops including means of generating vortex structures.

Thus, a spoiler is obtained capable not only of cleaning the rear window by means of the conduit to route air towards the upper part of the window, air subsequently propagating along the rear window when the scoops are in the extended position, but these scoops also include means that, in the extended position, can create vortices, in other words vortex structures that make it possible to not decrease, and possibly improve, aerodynamic performances.

Optionally, the spoiler according to the invention may include one or several of the following characteristics taken separately or in combination:
the scoops include two flanks and an upper wall connecting the two flanks, the upper wall being at an angle with the roof in the extended position so that vortices can be created;
a spacing between the flanks at one end of the scoops is larger than a spacing between the flanks at another end of the scoops;
the upper wall extends on each side of the flanks in a direction parallel to that of the top wall;
the spoiler also includes a moving aerodynamic blade;
the spoiler includes a scoop actuation device and the aerodynamic blade comprising a rack and pinion system comprising a toothed wheel and parallel racks, each of the two racks cooperating with one of the scoops and the aerodynamic blade;
the rack cooperating with the aerodynamic blade comprises a curved end;
the rack cooperating with a scoop comprises a stop located at its end cooperating with the scoop;
the actuation means comprise a means of returning the scoop, particularly a classical spring or shape memory spring;
the spoiler comprises several rods that can be used for extension and retraction of the aerodynamic blade;
the scoops are mounted such that in the folded position, a top face of the scoops is flush with the top face of the spoiler;
the scoops are covered in the folded position by a cache flush with the upper face of the spoiler or by the aerodynamic blade, and;
the cache or the aerodynamic blade can be extended before or at the same time as the scoops.

We will now present embodiments of the invention with reference to the appended figures that are provided as examples and that are in no way limitative, in which:

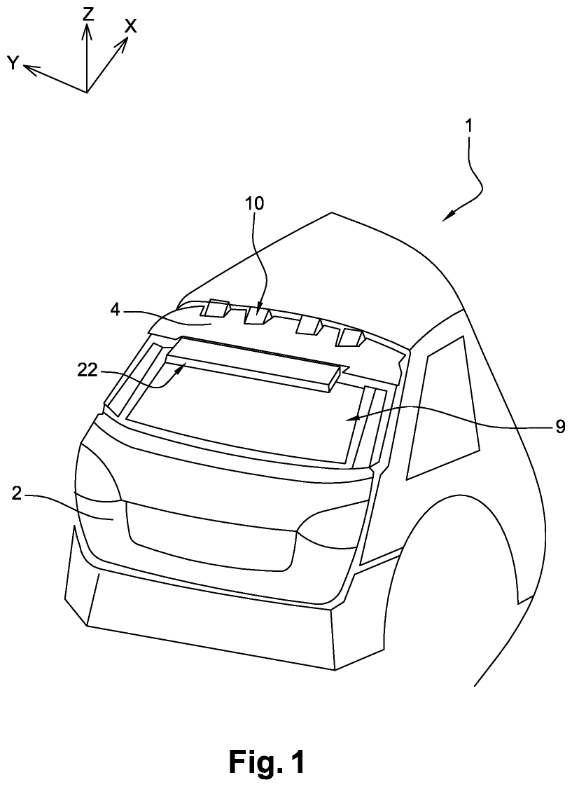

FIG. 1 is a perspective view of a rear portion of a vehicle comprising a spoiler according to a first embodiment of the invention;

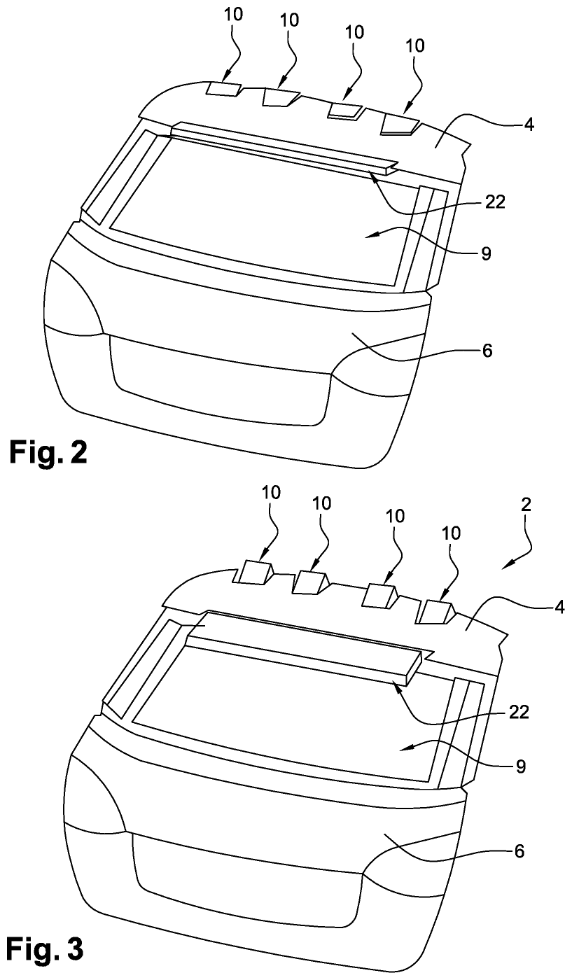

FIGS. 2 and 3 are perspective views of a rear portion of an automobile vehicle comprising a spoiler according to the invention;

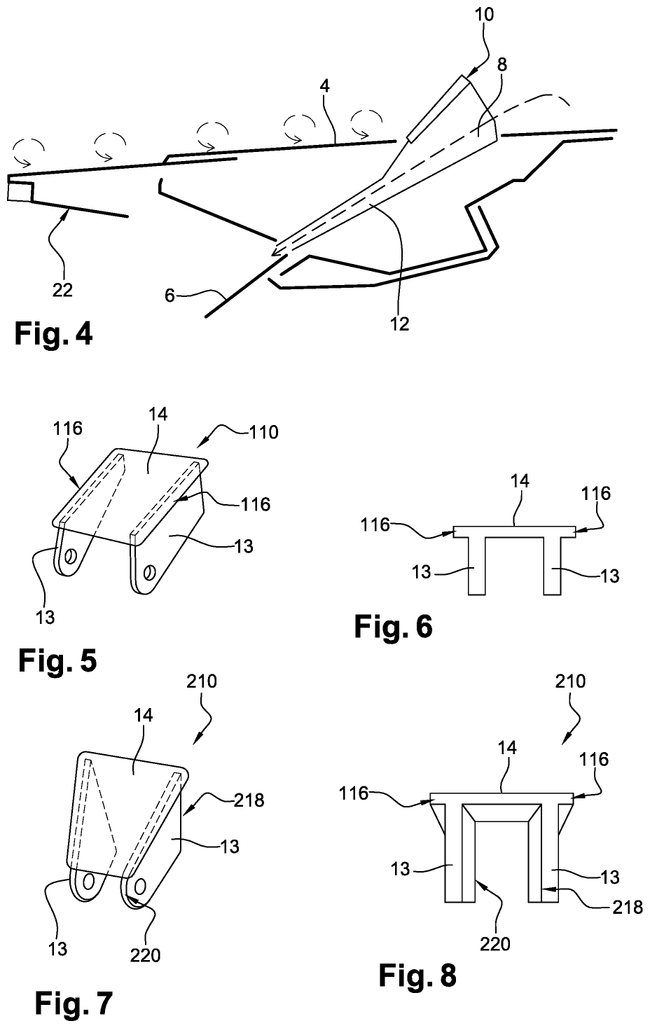

FIG. 4 is a partial sectional view of a rear portion of an automobile vehicle comprising the spoiler in FIGS. 1 to 3;

FIGS. 5 and 6 are perspective and sectional views respectively of a scoop according to a second embodiment;

FIGS. 7 and 8 are perspective and sectional views respectively of a scoop according to a third embodiment;

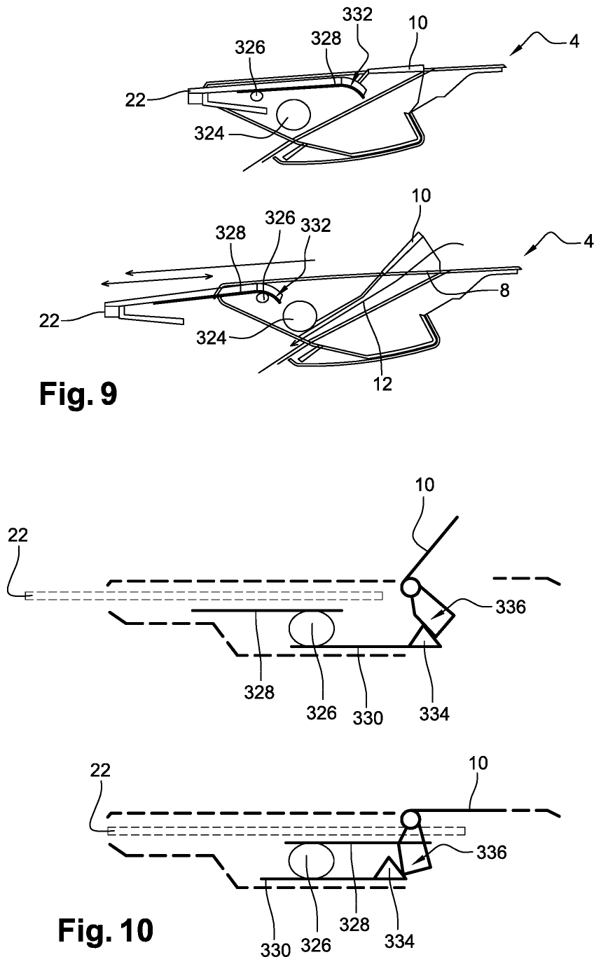

FIG. 9 is a diagrammatic representation of a spoiler comprising a scoop and a mobile aerodynamic blade in the folded position and then in the extended position according to a fourth embodiment of the invention;

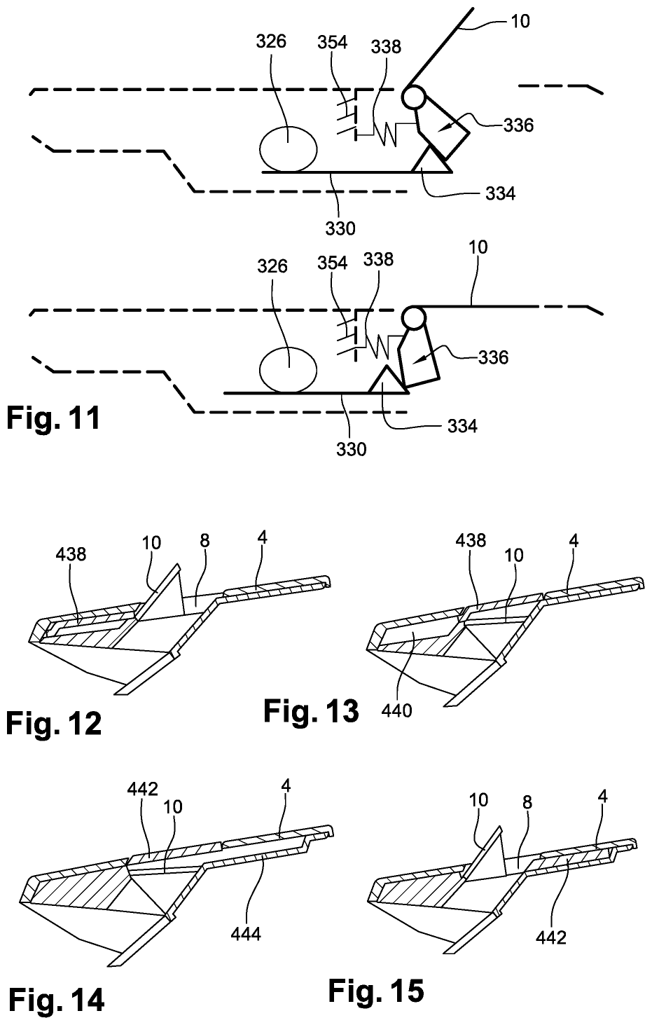

FIGS. 10 and 11 are diagrammatic representations representing variants of the system for extension and retraction of the scoop and the aerodynamic blade in the folded position and then in the extended position;

FIGS. 12 and 13 are sectional views of a spoiler according to a fifth embodiment of this invention;

FIGS. 14 and 15 are sectional views representing a variant of the spoiler in FIGS. 12 and 13;

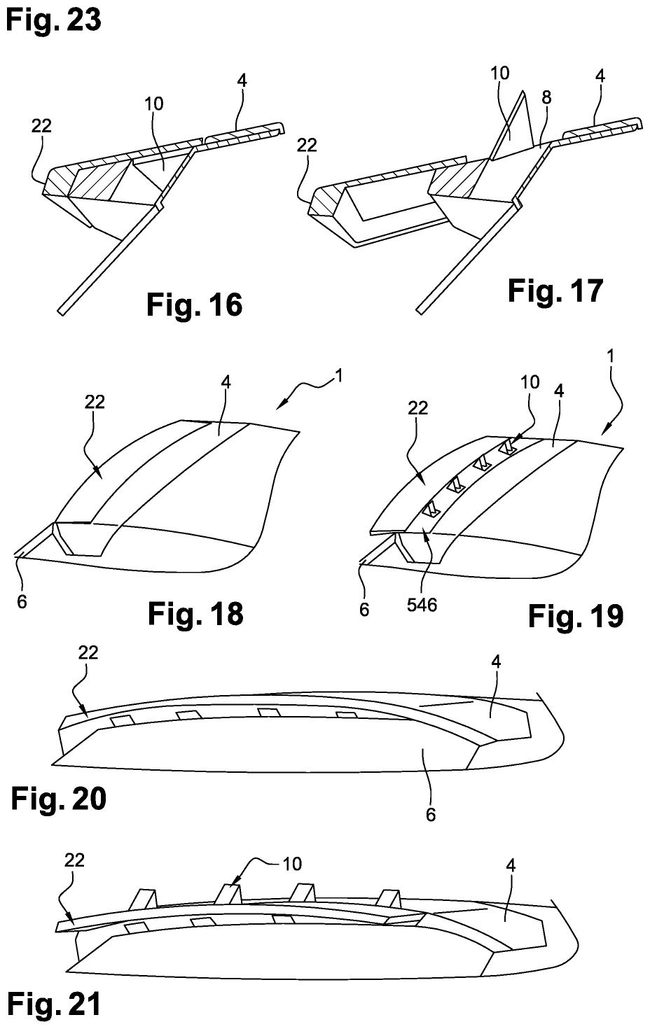

FIGS. 16 and 17 are sectional views of a spoiler according to a sixth embodiment of the invention;

FIGS. 18 to 21 are perspective views of the spoiler in FIGS. 16 and 17; and

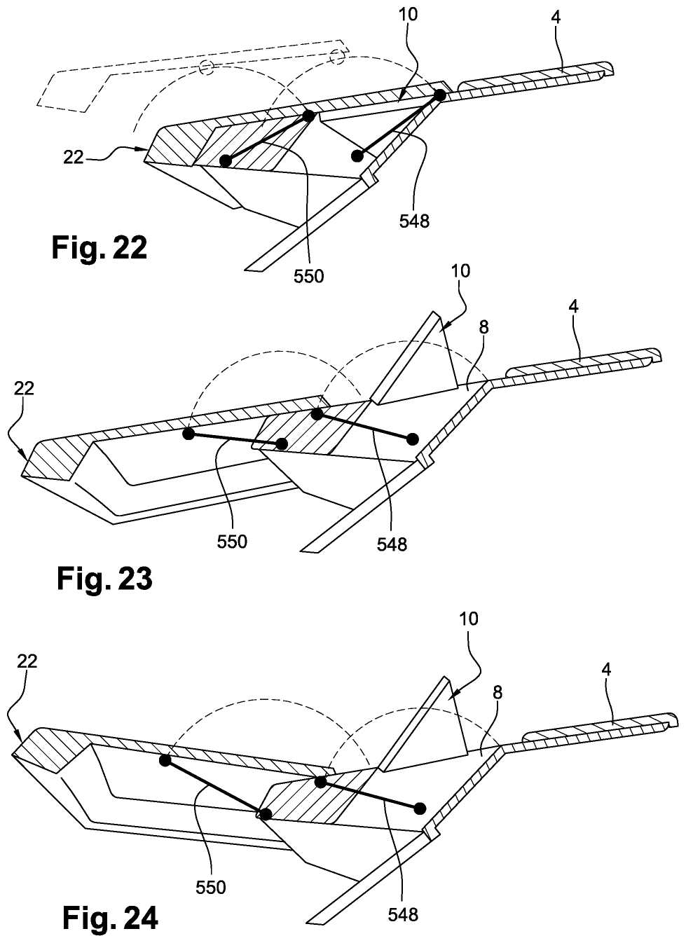

FIGS. 22 to 24 are variants of the spoiler in FIGS. 16 and 17.

Refer now to FIGS. 1 to 4 that represent a vehicle 1 comprising a rear portion 2 itself comprising a spoiler 4 and a rear door 6. The spoiler 4 for an automobile vehicle according to the invention will be located in a region of a rear edge of the roof, above a rear window 9. The spoiler can thus be fixed on the roof, or mounted on the rear door 6.

The spoiler 4 comprises a conduit 12 connecting the upper face of the spoiler 4 to the upper portion of the external face of the rear window 9 so that some of the air from the roof is deviated inside the conduit 12 and can sweep over the rear window 9 at the outlet from the conduit 12 at a specific region. Preferably, this region corresponds essentially to the rear view region of the vehicle that must therefore be the surface to be cleaned. Rear view means the driver's view field when he looks behind the vehicle through the rear view mirror 9.

In the example illustrated, the spoiler 4 also comprises four openings 8 on its upper face, into which the conduit 12 opens up. Each opening 8 is associated with a scoop 10. A scoop is a hollow body composed of two lateral flanks and an upper wall, with an opening facing an air flow from the roof and that can direct air towards the inlet to the conduit 12.

In the example described, the openings 8 made in the spoiler 4 are approximately all in line with the others along a longitudinal direction of the spoiler 4. This direction is a direction parallel to a transverse Y axis of the vehicle and will be mentioned subsequently as such. However, the openings 8 made in the spoiler can be arranged along a curve following the radius of curvature around the transverse axis of the spoiler and/or the Z axis of the vehicle.

Orientation terms such as the “longitudinal X axis”, “transverse Y axis”, “vertical Z axis”, “front”, “back”, “above”, ‘higher”, “below”, “lower”, etc. refer to the usual orientation of automobile vehicles according to the coordinate system shown on FIG. 1.

The scoops 10 are free to move. They are represented in the folded position on FIG. 2 and in the extended position on FIGS. 3 and 4. For example, scoops can be extended by rotation or by translation.

A scoop 10 comprises three walls: two lateral flanks 13 above which there is an upper wall 14.

The shape and position of the scoops are configured such that vortices are created.

A vortex is the formation of a specific vortex structure. Patent EP 1 740 442 describes the use of vortex generation devices so as to improve the air flow in a zone located downstream from the vehicle when it is running, zone comprising a shear layer and a principal return vortex.

The means present on the scoops of the spoiler create vortices with the following characteristics taken alone or in combination:
the spoiler 4 comprises a plurality of scoops with an opening facing the air flow from the roof,
the width/height aspect ratio of the scoop is sufficient so that vortex structures can be generated. This aspect ratio is ideally of the order of 1.
the scoop may include lateral shoulders 116 located at the intersection between each flank 13 and the upper wall 14 and extending along a longitudinal direction of the spoiler beyond from the extent of the flanks;
the two lateral flanks 13 form a channel that narrows along the direction of the air flow. The upper wall can then be trapezoidal in shape, with the widest part being oriented towards the front of the vehicle;

In the extended position, the upper wall 14 forms an angle with the upper surface of the spoiler 4 that, in combination with the projection height of the scoop projecting above the spoiler, helps to create vortices. The angle formed may be between 10 and 80°, for example about 45°, as shown on FIG. 4. The projection height of the scoop may be between 20 and 80 mm, and preferably between 20 and 60 mm. In the embodiment shown on FIGS. 2 and 3, the two flanks 13 are parallel and located in planes normal to Y. The upper wall 14 connects the two flanks 13 and is approximately perpendicular to them. When the scoop is in the retracted position, the upper wall 14 is aligned with the spoiler 4 and its upper face is flush with the upper face of the spoiler 4.

Other embodiments of the invention will be described in what follows, with reference to FIGS. 5 to 24. On these figures, elements corresponding to elements in the previous figures are designated by identical numerical references. Modified elements or new elements will be numbered in increments of one hundred, each hundred corresponding to an embodiment.

In a second embodiment represented on FIGS. 5 and 6, a scoop 110 comprises two flanks 13 and the upper wall 14. The flanks 13 and the upper wall 14 extend in exactly the same directions as in the first embodiment. The general shape of the scoop 110 is similar to the shape of the first embodiment. However, the upper wall 14 comprises two lateral shoulders 116 located at the ends of the upper wall 14 on each side of the flanks 13 and extending locally in the same direction as the upper wall 14. This arrangement allows the creation of vortices when running, during which the air flow will locally strike the lateral shoulders 116. The shape and the size of the lateral shoulders 116 can vary from one scoop to another.

According to a third embodiment of the invention represented in FIGS. 7 and 8, a scoop 210 comprises flanks 13 and the upper wall 14. The upper wall 14 extends in a direction similar to that in the first two embodiments. Concerning the flanks 13, the space between the flanks at one end 218 of the scoop is larger than the space between the flanks at another end of the scoop 220. In other words, the two flanks 13 are not parallel and the scoop 10 becomes narrower with increasing distance along the air flow direction. In fact, the end 218 is the end through which air enters the scoop and the end 220 is the end of the scoop 210 closest to the conduit 12 in the open position. Therefore the channel formed by the flanks 13 and the upper wall 14 tends to become smaller along the air flow direction. This scoop shape directs the air flow so that it sweeps the rear window. The difference in spacing between the ends 218 and 220 can vary so as to adjust the narrowing effect of the channel on the creation of vortices. The shape of the upper wall 14 can be adapted to the change in spacing between the two flanks. A scoop according the third embodiment of the invention may or may not have lateral shoulders 116 like the scoop according to the second embodiment.

According to a fourth embodiment of the invention represented by different variants in FIGS. 9 to 11, the spoiler 4 may also include a mobile aerodynamic blade 22 represented in the folded position on FIG. 2 and in the extended position on FIGS. 3 and 5. The extended aerodynamic blade 22 can even further improve the aerodynamic effect by shifting air separation points from the vehicle, in other words the points at which air no longer follows the bodywork, towards the back of the vehicle. This aerodynamic blade 22 comprises a seal (not shown) extending on its upper face and on its internal edge. The spoiler 4 comprises means of central and lateral guidance (not shown) of the aerodynamic blade 22 relative to the fixed part of the spoiler 4.

In order to extend the scoops and the aerodynamic blade, the spoiler 4 comprises means of actuating the scoops and the aerodynamic blade located in the volume of the spoiler.

These actuation means comprise a rack and pinion system comprising a motor 324 capable of moving a toothed wheel 326. Two racks 328 and 330 located on opposite sides of the toothed wheel 326 displace the aerodynamic blade 22 and the scoops 10 between a folded position and an extended position, respectively. More precisely, the consequence of rotation of the toothed wheel 326 is to provoke a simultaneous translational displacement of the two racks 328 and 330 that is possible along the same line and in two opposite directions to extend and retract the scoop 10 and the aerodynamic blade 22. In this case the two racks 328 and 330 are located on opposite sides of the toothed wheel but they could be offset from each other along the Y direction.

In a variant shown on FIG. 9, the rack 328 cooperating with the aerodynamic blade 22 comprises a curved end. This is the end 332 in contact with the toothed wheel 326 when the aerodynamic blade 22 is fully extended. This shape makes it possible to tilt the aerodynamic blade 22 at the end of its extension. The tilt is made downwards on FIG. 10, but the use of an upwards tilt could be envisaged. A downwards inclination can reduce drag of the vehicle, while an upwards inclination can increase the downforce on the vehicle and therefore increase the force on the rear axle.

In one variant shown on FIGS. 10 and 11, the second rack 330 cooperating with the scoop 10 comprises a stop 334 at its end that can come into contact with the scoop 10. The shape of this stop can be complementary to the inner part 336 of the scoop 10. This complementarity enables the inner part 336 to bear on the stop 334 when the scoop 10 is in the extended position, as shown on FIGS. 10 and 11.

In another variant represented on FIG. 11, the means of actuating the scoop 10 and the aerodynamic blade 22 include return means 338.

The return means make it easier to fold the scoop 10. They may be of any nature compatible with the invention, for example they may use a conventional spring or a shape memory spring. These means are connected firstly to a scoop 10 and secondly to a fixed part 354 of the extension/folding mechanism.

In this fourth embodiment, in the examples shown on FIGS. 9, 10 and 11, the scoop 10 and the aerodynamic blade 22 are extended and retracted at the same time. It is also possible that they could be extended one after the other making use of a mechanism to separate movements of the different bodies.

Also, the fourth embodiment represents a scoop 10 mounted such that, in the folded position, the upper face of the scoop is flush with the upper face of the spoiler 4. It could be envisaged otherwise, as will be described later.

In a fifth embodiment represented in FIGS. 12 to 15, the top face of the scoop 10, when in the folded position, is not flush with the upper face of the spoiler 4 but is lower than it, so that it will be covered when it is the folded position.

In a first variant illustrated in FIGS. 12 and 13, the scoop 10 in the folded position is covered by a cache 438, the upper face of which is flush with the upper face of the spoiler 4. When the scoop has to be extended, the cache 438 is displaced, for example by slides (not represented) any other retraction system adapted to the invention, so as to be housed in a space 440 under the rear part of the upper face of the spoiler, in other words in its part furthest from the roof of the vehicle. The retraction enables extension of the scoop 10.

In one variant represented in FIGS. 14 and 15, the scoop 10 is also covered by a cache 442 covering the scoop 10 in the same way as the cache 438. However during extension of the scoop 10, the cache 442 is retracted by a system equivalent to that shown in FIGS. 12 and 13, inside a space located under the upper face of the spoiler 4, and more precisely in its part closest to the roof of the vehicle.

In a sixth embodiment of the invention represented in FIGS. 16 to 24, the aerodynamic blade 22 also acts as a cache, like part 442 of the 5^{th} embodiment.

In the folded position, the aerodynamic blade 22 covers the scoops and its upper face is flush with the upper face of the remainder of the spoiler 4, as shown on FIGS. 18, 20 and 22. The upper face of the aerodynamic blade 22 is also aligned with the upper face of the spoiler 4. The blade is extended before the scoops 10 and in the extended position, the blade releases a space 546 including the openings 8 and the scoops 10.

The means of actuating the aerodynamic blade 22 and the scoops 10 may be similar to the means described above, in other words making use of a rack and pinion system but with sufficient desynchronisation of movements so that the blade is sufficiently offset before extension of the scoops starts. However, it could be a system of rods as shown on FIGS. 22 to 24.

The spoiler 4 comprises rods 548 and 550 or 548 and 552 capable of displacing the aerodynamic blade 22.

As shown on FIG. 24, the system of rods can be adjusted such that in the extended position, the aerodynamic blade 22 does not form an imaginary prolongation of an air line from the roof, but on the contrary is inclined, for example upwards, so as to confer an aerodynamic downforce effect. Once again, it could be envisaged that this inclination is downwards instead of upwards.

During extension and retraction, the aerodynamic blade will occupy an intermediate position higher than the remaining part of the spoiler 4 as illustrated in dashed lines on FIG. 24.

In the fourth embodiment of the invention, the scoops 10 and the aerodynamic blade 22 are firstly folded, the scoops 10 having their upper faces flush with the upper face of the spoiler 4.

When starting up the actuation means, the motor 324 actuates the toothed wheel 326 that will move the racks 328 and 330 in translation so as to extend the aerodynamic blade and scoops at the same time. The scoops are extended due to the action of the stop 334 and are held stable in the extended position, due particularly to the presence of a stop element at the maximum opening of the scoops (not shown). The aerodynamic blade 22 can be inclined due to the curved end 332 of the rack 328.

During retraction, the toothed wheel 326 will turn in the direction opposite to its direction during extension, to bring the racks 328 and 330 back into the position that they occupied before deployment. This retraction can be optimised by the action of return means 338.

In the fifth and sixth embodiments of the invention, the cache 438/442 or the aerodynamic blade 22 covers the scoops 10 in the folded position.

The actuation means will firstly extend the aerodynamic blade 22 or retract the caches 438 or 442 so that the scoops 10 can be extended.

During retraction, the scoops 10 are folded first. The caches 438 and 442 or the aerodynamic blade 22 then being displaced to once again cover the scoops 10. It could be envisaged that the scoops 10 could be folded by the aerodynamic blade 22 when this blade is folded. Similarly, it is possible that the scoops 10 extend at least partially when the aerodynamic blade 22 is extended, for example using one or several springs for each scoop. This deployment can be completed by air funneled into the scoops when running.

The invention is not limited to the embodiments presented and other embodiments will become apparent to those skilled in the art.

For example, the scoops can have a lower wall to form a tubular structure.

### PARTS LIST

### 1^{st} Embodiment

1: vehicle
2: rear portion of vehicle
4: spoiler
6: rear door
8: opening
9: rear window
10: scoop
12: conduit
13: scoop flanks
14: scoop upper wall
22: aerodynamic blade

### 2^{nd} Embodiment

110: scoop
116: lateral shoulders

### 3^{rd} Embodiment

210: scoop
218: 1^{st} end of scoop
220: second end of scoop

### 4^{th} Embodiment

324: motor
326: toothed wheel
328: 1^{st} rack
330: 2^{nd} rack
332: curved end of the 1^{st} rack
334: stop
336: scoop inner part
338: return means
354: fixed part

### 5^{th} Embodiment

438: 1^{st} cache variant
440: 1^{st} space
442: 2^{nd} cache variant
444: 2^{nd} space

### 6^{th} Embodiment

546: space containing the scoops
548: 1^{st} rod
550: 2^{nd} rod
552: 3^{rd} rod

1. Spoiler (4) for an automobile vehicle designed to be located in a region near a rear edge of the roof above a rear window (9), characterised in that it comprises:
several openings (8) located on an upper face of the spoiler (4), and
several conduits (12) designed to connect the openings (8) to a lower face of the spoiler (4),
the spoiler (4) comprises several scoops (10; 110; 210) mounted in mobile openings (8) and free to move relative to the spoiler (4) so as to close off the openings (8) when in the folded position, and to perform a guidance function when in the extended position, to allow air flow along the rear window (9), the scoops (10; 110; 210) including means of generating vortex structures.

2. Spoiler (4) according to claim 1, in which the scoops (10; 110; 210) comprise two flanks (13) and an upper wall (14) connecting the two flanks (13), the upper wall (14) forming an angle with the roof in the extended position capable of creating vortices.

3. Spoiler (4) according to claim 2, in which a separation between the flanks (13) at one end (218) of the scoops (210) is larger than a separation between the flanks (13) at another end (220) of the scoops (210).

4. Spoiler (4) according to any one of claims 2 or 3, in which the upper wall (14) extends on each side of the flanks (13) in a direction parallel to that of the top wall.

5. Spoiler (4) according to any one of the preceding claims, the spoiler (4) also comprising a mobile aerodynamic blade (22).

6. Spoiler (4) according to claim 5, comprising a scoop actuation device and the aerodynamic blade comprising a rack and pinion system comprising a toothed wheel (326) and parallel racks (328, 330), each of the two racks (328, 330) cooperating with one of the scoops (10; 110; 210) and the aerodynamic blade (22).

7. Spoiler (4) according to claim 6, in which the rack (328) cooperating with the aerodynamic blade (22) comprises a curved end (332).

8. Spoiler (4) according to any one of claims 6 or 7, in which the rack (330) cooperating with a scoop (10; 110; 210) comprises a stop (334) located at one end cooperating with the scoop (10; 110; 210).

9. Spoiler (4) according to any one of claims 6 to 8, in which the actuation means comprise a means (338) of returning the scoop (10; 110; 210), particularly a classical spring or a shape memory spring.

10. Spoiler (4) according to claim 5, comprising—several rods (548, 550, 552) that can be used for extension and retraction of the aerodynamic blade (22).

11. Spoiler (4) according to any one of the preceding claims, in which the scoops (10; 110; 210) are mounted such that, in the folded position, an upper face of the scoops (10; 110; 210) is flush with the upper face of the spoiler (4).

12. Spoiler (4) according to any one of claims 1 to 10, in which the scoops (10; 110; 210) are covered in the folded position by a cache (438, 442) flush with the top face of the spoiler or by the aerodynamic blade (22).

13. Spoiler (4) according to claim 12, in which the cache (438, 442) or the aerodynamic blade (22) is capable of being extended before or at the same time as the scoops (10; 110; 210).
